(19) United States
(12) Patent Application Publication
(10) Pub. No.: US 2015/0246317 A1
(43) Pub. Date: Sep. 3, 2015

(54) METHOD FOR PRODUCING FILTRATION FILTER

(71) Applicant: TOKYO ELECTRON LIMITED, Minato-ku, Tokyo (JP)

(72) Inventors: Tsuyoshi Moriya, Tokyo (JP); Sensho Kobayashi, Nirasaki-shi (JP); Kenichi Kagawa, Tokyo (JP); Tsutomu Sakurabayashi, Nirasaki-shi (JP)

(73) Assignee: TOKYO ELECTRON LIMITED

(21) Appl. No.: 14/427,650

(22) PCT Filed: Sep. 11, 2013
(86) PCT No.: PCT/JP2013/075213

§ 371 Date: Mar. 12, 2015

(30) Foreign Application Priority Data
Sep. 19, 2012 (JP) 2012-205482

(51) Int. Cl. B01D 67/00; B01D 69/06

(52) U.S. Cl. CPC B01D 67/0034; B01D 69/06; B01D 2323/24

(57) ABSTRACT

Provided is a method for producing a filtration filter capable of purifying with high accuracy and largely improving filtration efficiency. A flow path forming film is formed on a substrate. A plurality of grooves is formed on the flow path forming film along a surface of the substrate by etching. The grooves are filled with a sacrificial film. The flow path forming film and the sacrificial film are planarized by polishing the sacrificial film. A flow path sealing film is formed on the planarized flow path forming film and sacrificial film. An inlet hole and an outlet hole are formed through the substrate and the flow path sealing film, respectively, so that parts of the sacrificial film are exposed through the inlet hole and the outlet hole. The sacrificial film is removed using the inlet hole and the outlet hole and the filtration flow paths are formed by the grooves.

### TECHNICAL FIELD

The present disclosure relates to a method for producing a filtration filter using a semiconductor manufacturing technology.

### BACKGROUND

A manufacturing process of medical and pharmaceutical products having polymer compounds mainly includes a culture process, a purification process, and a formulation process. In the culture process, an objective material, e.g., polymer compounds which become medical and pharmaceutical components, is cultured in a culture tank. In the purification process, polymer compounds are subjected to the purification using a filtration filter such as a reverse osmosis membrane or the like. In the formulation process, the purified polymer compounds are formulated as medical and pharmaceutical products. The purification process takes the longest time among the aforementioned three processes. For this reason, in order to increase efficiency in manufacturing the medical and pharmaceutical products, an efficient purification of polymer compounds is needed.

However, a typical reverse osmosis membrane is mainly composed of a polymer membrane and has a low strength. For that reason, there is a problem that when a load is applied in a state where the pressure of a target fluid to be purified is increased so as to improve the purification efficiency, the membrane is broken. Therefore, a reverse osmosis membrane formed of a porous member such as a porous ceramic having high rigidity has been developed (for example, see Patent Document 1).

### PRIOR ART DOCUMENTS

### Patent Documents

Patent Document 1: Japanese Patent Application Publication No. 2007-526819

However, although using the reverse osmosis membrane of the porous member can slightly enhance the efficiency of filtration by increasing the pressure of a target fluid to be purified, the diameter of a penetration hole in the porous member cannot be controlled directly in the manufacturing process of the porous member. Therefore, for example, despite a situation where a penetration hole in a reverse osmosis membrane having a diameter equal to or less than several nanometers is required, many penetration holes having a diameter larger than several nanometers, e.g., tens of nanometers exist in the porous member. In a certain case, several penetration holes having a diameter of hundreds of nanometers may exist. For that reason, the reverse osmosis member formed of a porous member cannot perform purification with high-precision.

Moreover, since an opening rate of the penetration hole of the porous member is only 1%, increasing pressure of the target fluid cannot lead to a large improvement in the filtration efficiency.

### SUMMARY

The object of the present disclosure is to provide a method for producing a filtration filter which can perform purification with high-precision and can largely improve the efficiency of filtration.

In order to solve the problem, according to the present disclosure, there is provided a method for producing a filtration filter having a filtration flow path therein, the method including: forming a first film on a substrate, forming a groove on the first film by etching along a surface of the substrate, filling the groove with a sacrificial film, polishing the sacrificial film to planarize a surface of the first film and a surface of the sacrificial film, forming a second film on the first film and the sacrificial film, forming a substrate penetrating portion through a portion of the substrate by etching and forming a second film penetrating portion through a portion of the second film by etching, so that portions of the sacrificial film are exposed at the substrate penetrating portion and the second film penetrating portion, respectively, and removing the sacrificial film through the substrate penetrating portion and the second film penetrating portion to form the filtration flow path by the groove.

In the present disclosure, it is preferable that one end of the sacrificial film is exposed at the second film penetrating portion, and the other end of the sacrificial film is exposed at the substrate film penetrating portion.

In the present disclosure, it is preferable that a through-hole is formed through the first film and the second film such that the through-hole communicates with the substrate penetrating portion.

In the present disclosure, it is preferable that thinning the substrate by polishing before forming the substrate penetrating portion is included.

In the present disclosure, it is preferable that the sacrificial film is removed by using a hydrofluoric acid vapor in the removing the sacrificial film.

In the present disclosure, it is preferable that the first film, the second film and the sacrificial film are formed by one selected from a group consisting of CVD, PVD and ALD.

In the present disclosure, it is preferable that a plurality of the grooves is formed.

According to the present disclosure, it is possible to perform purification with high-precision and largely improve the efficiency of filtration.

### BRIEF DESCRIPTION OF THE DRAWINGS

FIGS. 1A to 1C are views schematically illustrating a configuration of a filtration filter manufactured by a method for producing a filtration filter according to an embodiment of the present disclosure, wherein FIG. 1A is a perspective view illustrating an appearance of the filtration filter, FIG. 1B is a partial cross-sectional view taken along a line B-B in FIG. 1A and FIG. 1C is a partially enlarged cross-sectional view illustrating a cross-sectional shape of flow paths in the filtration filter.

FIGS. 2A to 2J are process diagrams illustrating a method for producing the filtration filter according to the embodiment.

FIGS. 3A to 3C are process diagrams illustrating a modified example of the method for producing the filtration filter according to the embodiment.

### DETAILED DESCRIPTION

Hereinafter, embodiments of the present disclosure will be described with reference to the drawings.

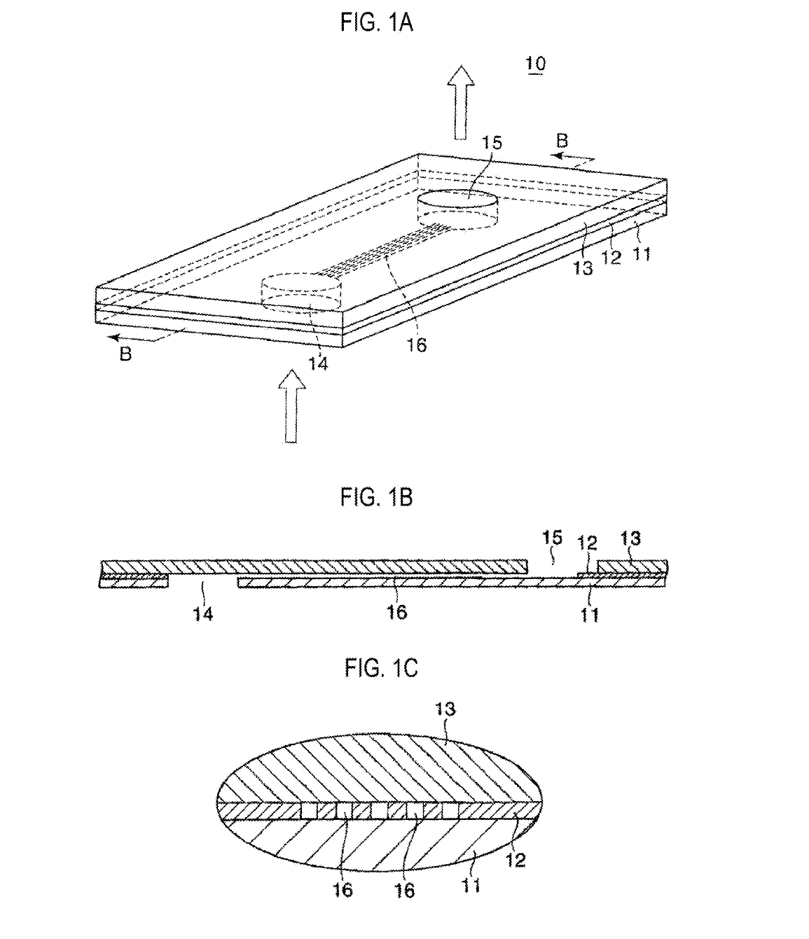

FIGS. 1A to 1C are views schematically illustrating a configuration of a filtration filter manufactured by a method for producing a filtration filter according to an embodiment of the present disclosure. Specifically, FIG. 1A is a perspective view illustrating an appearance of the filtration filter, FIG. 1B is a partial cross-sectional view taken along a line B-B shown in FIG. 1A, and FIG. 1C is a partially enlarged cross-sectional view illustrating a cross-sectional shape of flow paths in the filtration filter.

In FIGS. 1A and 1B, a filtration filter 10 includes a substrate 11 made of, e.g., silicon, a flow path forming film 12 (a first film) formed of a thermal oxide film formed on the substrate 11, a flow path sealing film 13 (a second film) formed of a thermal oxide film formed on the flow path forming film 12.

In the substrate 11 and the flow path forming film 12, an inlet hole 14 (a substrate penetrating portion) extending through the substrate 11 and the flow path forming film 12 in the thickness direction is formed. In the flow path sealing film 13, an outlet hole 15 (a second film penetrating portion) extending through the flow path sealing film 13 in the thickness direction is formed. The inlet hole 14 and the outlet hole 15 are connected by a plurality of filtration flow paths 16.

Each of the filtration flow paths 16 is formed along the surface of the substrate 11 and has a rectangular cross section as shown in FIG. 1C. For example, a width of each of the filtration flow paths 16 is 400 nm and a height thereof is 400 nm. Although a cross section of each of the filtration flow paths 16 is described as a rectangular shape in this embodiment, the cross section may be arbitrarily selected. For example, a shape of the cross section may be a trapezoid, a rectangular or trapezoid having a curved oblique side, or the like.

In the filtration filter 10, as shown in FIG. 1A with arrows, a target fluid to be purified is introduced into the inlet hole 14 and discharged through the outlet hole 15, passing through each of the filtration flow paths 16. When the target fluid flows through each of the filtration flow paths 16, impurities larger than the cross section of the filtration filter 16 are removed from the target fluid. Therefore, polymer compounds smaller than the cross section of each of the filtration flow paths 16 may be purified from the target fluid.

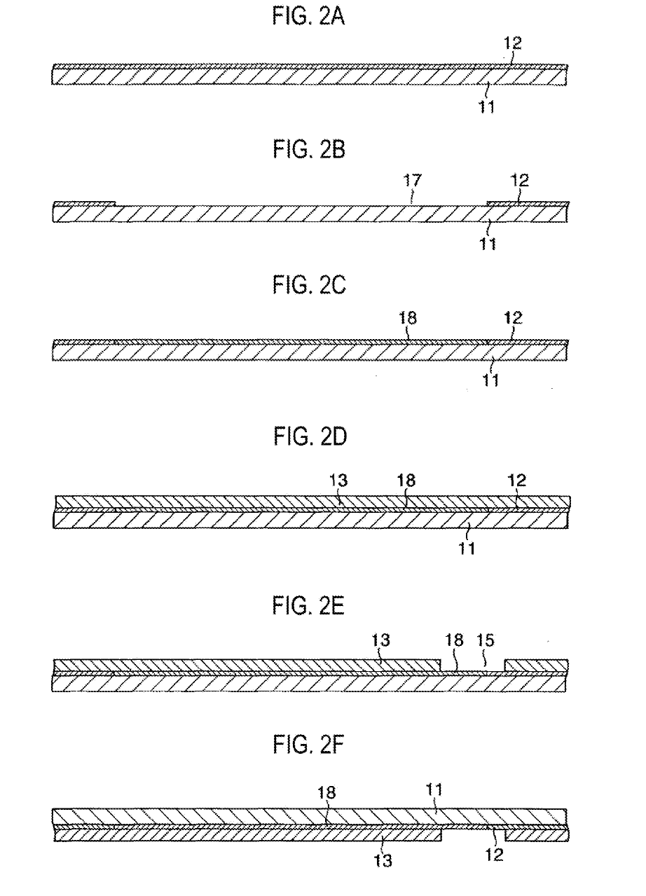

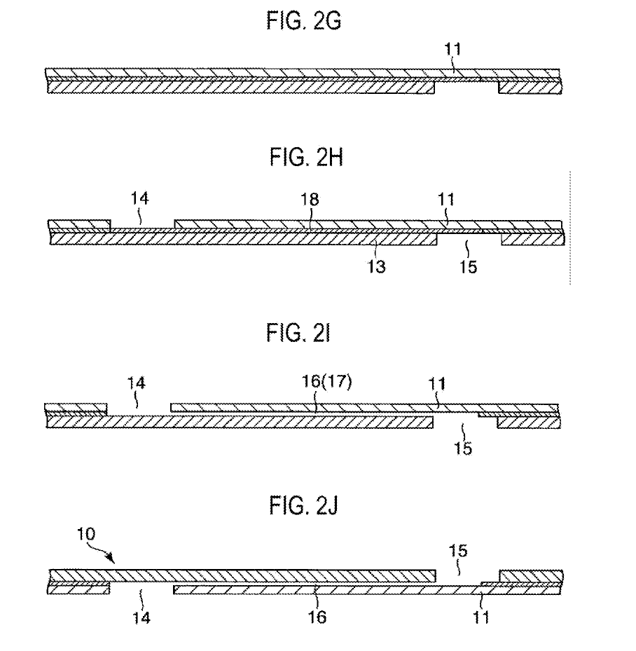

FIGS. 2A to 2J are process diagrams illustrating the method for producing the filtration filter according to the embodiment.

Firstly, the flow path forming film 12 having a thickness of, e.g., 400 nm is formed on the substrate 11 by means of the thermal Chemical Vapor Deposition (CVD) method (FIG. 2A, a first film formation step). Further, the method for forming the flow path forming film 12 is not limited to the thermal CVD method. Plasma CVD using plasma, PVD (physical vapor deposition) or ALD (atomic layer deposition) may be used.

Next, a plurality of grooves 17 are formed on the flow path forming film 12 by means of photolithography technology of the semiconductor manufacturing technology. Specifically, after forming a mask (not shown) with a pattern where openings corresponding to the plurality of grooves 17 are formed over the flow path forming film 12, portions of the flow path film 12 exposed through the openings of the mask is removed by etching with plasma or chemical liquid, and then the plurality of grooves 17 along the surface of the substrate 11 are formed (FIG. 2B, a groove formation step). FIG. 2B is a cross-sectional view along the grooves 17. A width of each of the grooves 17 is, e.g., 400 nm The grooves 17 are arranged side by side in a depth direction of the drawing and are parallel with each other. Etching with plasma enables a microprocessing and a more accurate processing in dimension and shape than etching with chemical liquid. However, since etching with plasma needs a vacuum environment as the processing environment, it is required a large scale facility for the processing environment. Therefore, if a processing with high-precision in dimension or shape is not needed, etching with chemical liquid may be performed in the processing environment of facilities that are more economically prepared.

Next, the grooves 17 are filled with a sacrificial film 18 formed of a nitride film by the CVD method (a sacrificial film fill step). Then, the sacrificial film 18 protruding from the grooves 17 is polished by means of CMP (chemical mechanical polishing) method or the like, whereby the surfaces of the flow path forming film 12 and the sacrificial film 18 are planarized (FIG. 2C, a planarization step). Moreover, the method for forming the sacrificial film 18 is not limited to CVD method and PVD method or ALD method may be used.

Next, the flow path sealing film 13 is formed on the flow path forming film 12 and the sacrificial film 18 by means of the thermal CVD method (FIG. 2, a second film formation step). This makes the sacrificial film 18 sealed by the flow path sealing film 13. Moreover, the method for forming the flow path sealing film 13 is not limited to the thermal CVD method and the CVD method using plasma, PVD or ALD may be used.

Next, the outlet hole 15 is formed by removing a portion of the flow path sealing film 13 near an end portion of the sacrificial film 18 by etching, so that the end portion (one end) of the sacrificial film 18 is exposed at a bottom of the outlet hole 15 (FIG. 2E, a sacrificial film exposure step). At this time, a portion of the flow path forming film 12 may be exposed at the bottom of the outlet hole 15 depending on the purpose of use.

Next, the substrate 11 is positioned on the top of the others by reversing the substrate 11, the flow path forming film 12, the sacrificial film 18 and the flow path sealing film 13 in an up-down direction (FIG. 2F). Then, a lower surface of the substrate 11 (a top surface in the drawing) is polished by the CMP method or the like, whereby the substrate 11 becomes thinner (FIG. 2G, a thinning step).

Next, the inlet hole 14 is formed by removing a portion of the substrate 11 near an end portion of the sacrificial film 18 opposite to the outlet hole 15 by etching, so that the end portion (the other end) of the sacrificial film 18 is exposed at the bottom of the inlet hole (FIG. 2H, a sacrificial film exposure step). At this time, like the aforementioned case of the outlet hole 15, a portion of the flow path forming film 12 may be exposed at the bottom of the inlet hole 15 depending on the purpose of use.

Next, the sacrificial film 18 formed of a nitride film is removed by introducing, for instance, hydrofluoric acid vapor to the inlet hole 14 or the outlet hole 15 (a filtration flow path formation step). At this time, the grooves 17 from which the sacrificial film 18 is removed and the flow path sealing film 13 form the filtration flow paths 16 together (FIG. 2I).

Next, the substrate 11, the flow path forming film 12, the sacrificial film 18 and the flow path sealing film 13 are turned upside down in an up-down direction, so that the substrate 11 is put into a lowest position (FIG. 2J) and the process is completed.

In the method for producing the filtration filter according to the embodiment, since each of the grooves 17 forming each of the filtration flow paths 16 in the flow path forming film 12 is formed by the etching technology used for manufacturing a semiconductor, the widths of the grooves 17 can be controlled precisely. As a result, purification with high-precision can be performed by using the filtration flow paths 16 formed of the grooves 17. Moreover, since, unlike the machine work, etching enables a processing of forming a plurality of shapes in a lot, the number of the filtration flow paths 16 may be easily increased by forming a plurality of the grooves 17. Therefore, the efficiency of filtration may be largely increased.

Furthermore, the conductance of each of the filtration flow paths 16 is in inverse proportion to each length of the filtration flow paths 16. As described above, since etching enables forming whole shapes in a lot, a degree of freedom in forming shapes becomes high. Therefore, it is possible to freely set a position of the inlet hole 14 or the outlet hole 15 and a length of the groove 17. For example, by shortening each length of the grooves 17, each conductance of the filtration flow paths 16 may be increased. Therefore, by increasing the target fluid which flows in each of the filtration flow paths 16, the efficiency of filtration can be increased. In this case, the inlet hole 14 or the outlet hole 15 need not be formed near the end portion of the substrate 11. As long as the target fluid before purification and the target fluid after purification are not mixed, the inlet hole 14 or the outlet hole 15 may be formed near a center of the substrate.

In the aforementioned method for producing the filtration filter, since the one end of the sacrificial film 18 is exposed at the outlet hole 15, and the other end of the sacrificial film 18 is exposed at the inlet hole 14, the efficiency of removal of the sacrificial film 18 can be improved. Therefore, it is possible to prevent the sacrificial film 18 from remaining in the grooves 17 and to shorten a time for removal of the sacrificial film 18.

Furthermore, in the aforementioned method for producing the filtration filter, before forming the inlet hole 14 through the substrate 11, the substrate 11 is polished for thinning Therefore, in forming the inlet hole 14, a time required for penetrating the substrate 11 by etching can be shorten.

Furthermore, in the aforementioned method for producing the filtration filter, after reversing the substrate 11, the flow path forming film 12, the sacrificial film 18 and the flow path sealing film 13 in an up-down direction, the inlet hole 14 is formed on the substrate 11 by etching. Thus, during forming the inlet hole 14, the flow path sealing film 13 positioned lower than the substrate 11 contacts with, for instance, a mounting table mounting the filtration filter 10. Therefore, it is possible to prevent minute particles, which may scatter from the substrate 11 during etching, from adhering to the flow path sealing film 13.

Furthermore, in the aforementioned method for producing the filtration filter, since the flow path sealing film 13 for sealing the sacrificial film 18 is formed by means of the thermal CVD method, the thickness of the flow path sealing film 13 can be freely adjusted. Therefore, the thickness of the filtration filter 10 may be thinner, compared with the case in which the sacrificial film 18 is sealed by a glass substrate.

Next, a modified example of the method for producing the filtration filter according to the embodiment is explained below.

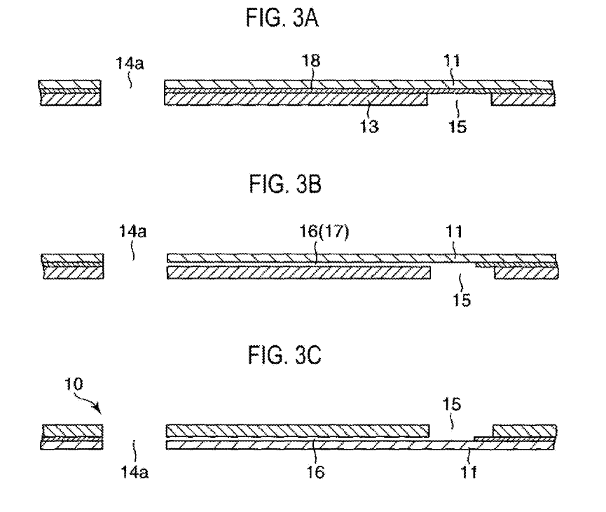

FIGS. 3A to 3C are process diagrams illustrating a modified example of the method for producing the filtration filter according to the embodiment. Moreover, other processes except the processes illustrated in FIGS. 3A to 3C are the same as those illustrated in FIGS. 2A to 2G and thus explanation thereof is omitted.

In this modified example, after reversing the substrate 11, the flow path forming film 12, the sacrificial film 18 and the flow path sealing film 13 in an up-down direction and thinning the substrate 11 by polishing the bottom surface of the substrate, i.e., after performing a process corresponding to FIG. 2G, an inlet hole 14a is formed through, by etching, portions of the flow path forming film 12, the sacrificial film 18 and the flow path sealing film 13 which are near the end portion of the sacrificial film 18 opposite to the outlet hole 15. In this way, the end portion (the other end) of the sacrificial film 18 is exposed on the side surface of an inlet hole 14a (FIG. 3A, a step for exposing the sacrificial film).

Next, the sacrificial film 18 formed of a nitride film is removed by introducing, for instance, hydrofluoric acid vapor to the inlet hole 14a or the outlet hole 15 (a step for forming the filtration flow paths). At this time, the grooves 17 from which the sacrificial film 18 is removed form the filtration flow paths 16 (FIG. 3B).

Next, the substrate 11, the flow path forming film 12, the sacrificial film 18 and the flow path sealing film 13 are turned upside down in an up-down direction, so that the substrate 11 is put into a lowest position (FIG. 3C) and the process is completed.

According to the modified example, since the inlet hole 14a extends through the substrate 11, the flow path forming film 12 and the flow path sealing film 13, a cross flow filtration in which a part of the target fluid flows for filtration separately from a main flow of the target fluid in a direction perpendicular to the main flow is available. The target fluid is divided into one partial flow which passes the inlet hole 14a and the other partial flow which flows to the outlet hole 15 through each of the filtration flow paths 16 from the inlet hole 14a. Especially, a ratio of flow rate between the one partial flow which passes the inlet hole 14a and the other partial flow which flows towards the outlet hole 15 may be controlled by adjusting an opening area of each of the flow paths 16 positioned at a side surface of the inlet hole 14a, whereby the efficiency of the filtration can be controlled.

While the present disclosure has been described with respect to certain embodiments, it is not limited to the embodiments described above.

For example, in the aforementioned method for producing the filtration filter, while the flow path forming film 12 and the flow path sealing film 13 are formed of a thermal oxide film, and the sacrificial film 18 is formed of a nitride film, the flow path forming film 12 and the flow path sealing film 13 may be formed of the nitride film, and the sacrificial film 18 may be formed of a thermal oxide film.

Moreover, in the aforementioned method for producing the filtration filter, since there is no limitation to the material of the substrate 11 as long as etching can be applied to the substrate 11, for example, flexible materials may be used as the substrate 11, whereby a flexible filtration filter 10 may be manufactured.

Furthermore, the use of the filtration filter manufactured by the aforementioned method for producing the filtration filter is not limited to manufacturing medical and pharmaceutical products and is also applicable to a field of food processing such as breweries, a field of water-purifying treatment technology for home/industry facilities, a field of waste water treatment technology for a semiconductor plant, etc., and a filed in which a high accuracy is needed in filtration and a throughput.

This application claims the benefit of Japanese Patent Application No. 2012-205482, filed on Sep. 19, 2012, in the Japan Patent Office, the disclosure of which is incorporated herein in its entirety by reference.

### EXPLANATION OF REFERENCE NUMERALS

10: filtration unit, 11: substrate, 12: flow path forming film, 13: flow path sealing film, 14: inlet hole, 14a: inlet hole, 15: outlet hole, 16: filtration flow path, 17: groove, 18: sacrificial film

1. A method for producing a filtration filter having a filtration flow path therein, the method comprising:
forming a first film on a substrate;
forming a groove on the first film by etching along a surface of the substrate;
filling the groove with a sacrificial film;
polishing the sacrificial film to planarize a surface of the first film and a surface of the sacrificial film;
forming a second film on the first film and the sacrificial film;
forming a substrate penetrating portion through a portion of the substrate by etching, and forming a second film penetrating portion through a portion of the second film by etching, so that portions of the sacrificial film are exposed at the substrate penetrating portion and the second film penetrating portion, respectively; and
removing the sacrificial film through the substrate penetrating portion and the second film penetrating portion to form the filtration flow path by the groove.

2. The method of claim 1, wherein one end of the sacrificial film is exposed at the second film penetrating portion, and the other end of the sacrificial film is exposed at the substrate film penetrating portion.

3. The method of claim 1, further comprising forming a through-hole which passes through the first film and the second film such that the through-hole communicates with the substrate penetrating portion.

4. The method of claim 1, further comprising thinning the substrate by polishing before forming the substrate penetrating portion.

5. The method of claim 1, wherein, in the removing the sacrificial film, the sacrificial film is removed by using a hydrofluoric acid vapor.

6. The method of claim 1, wherein the first film, the second film and the sacrificial film are formed by one selected from a group consisting of CVD, PVD and ALD.

7. The method of claim 1, wherein a plurality of the grooves is formed.
